(19) United States
(12) Patent Application Publication
(10) Pub. No.: US 2024/0425652 A1
(43) Pub. Date: Dec. 26, 2024

(54) METHODS OF PREPARING A COMPOSITE HAVING ELASTOMER AND FILLER

(71) Applicant: BEYOND LOTUS LLC, Wilmington, DE (US)

(72) Inventors: Martin C. Green, Boxborough, MA (US); Carlos Andres Echavarria Yepes, Chelmsford, MA (US)

(73) Assignee: Beyond Lotus LLC, Wilmington, DE (US)

(21) Appl. No.: 18/686,579

(22) PCT Filed: Sep. 2, 2022
(86) PCT No.: PCT/US2022/042465

§ 371 Date: Feb. 26, 2024

Related U.S. Application Data
(60) Provisional application No. 63/240,414, filed on Sep. 3, 2021.

(51) Int. Cl. C08J 3/205; C08L 7/00

(52) U.S. Cl. CPC C08J 3/2053; C08L 7/00; C08J 2307/00; C08J 2309/00

(57) ABSTRACT

Disclosed herein are methods of preparing a composite from at least a solid elastomer and a wet filler. In one or more mixing steps, the method comprises mixing the at least the solid elastomer and the wet filler to form a mixture and removing at least a portion of the liquid from the mixture by evaporation. One or more rotors of the mixer is mechanically coupled to a mixer motor and at least a portion of the mixing in step (b) is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point.

### FIELD OF THE INVENTION

Disclosed herein are methods of preparing composite by mixing at least solid elastomer and wet filler in which a portion of the mixing is performed under power control. Also disclosed are composites made by the present methods and corresponding vulcanizates derived from these composites.

### BACKGROUND

There is always a desire in the rubber industry to develop methods to disperse filler in elastomer and it is especially desirable to develop methods which can do so efficiently with respect to filler dispersion quality, time, effort, and/or cost.

Numerous products of commercial significance are formed of elastomeric compositions wherein reinforcing filler is dispersed in any of various synthetic elastomers, natural rubber or elastomer blends. Carbon black and silica, for example, are widely used to reinforce natural rubber and other elastomers. It is common to produce a masterbatch, that is, a premixture of reinforcing filler, elastomer, and various optional additives, such as extender oil. Such masterbatches are then compounded with processing and curing additives and upon curing, generate numerous products of commercial significance.

A good dispersion of reinforcing filler in rubber compounds has been recognized as a factor in achieving mechanical strength and consistent elastomer composite and rubber compound performance. Considerable effort has been devoted to the development of methods to improve dispersion quality, and various solutions have been offered to address this challenge. For example, more intensive mixing can improve reinforcing filler dispersion, but can degrade the elastomer into which the filler is being dispersed. This is especially problematic in the case of natural rubber, which is highly susceptible to mechanical/thermal degradation, especially under dry mixing conditions.

Accordingly, there is a need to develop methods to incorporate filler into solid elastomer to achieve acceptable or enhanced elastomer composite dispersion quality and functionality from elastomer composite masterbatches, which can translate into acceptable or enhanced properties in the corresponding vulcanized rubber compounds and rubber articles.

### SUMMARY

One aspect provides a method of preparing a composite, comprising:
(a) charging a mixer having one or more rotors with at least a solid elastomer and a wet filler comprising a filler and a liquid present in an amount of at least 15% by weight based on total weight of wet filler;
(b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
   (i) the mixer has at least one temperature-control means that is set to a temperature, Tz, of 65° C. or higher, and
   (ii) the one or more rotors operate, for at least 50% the mixing time, at a tip speed of at least 0.6 m/s; and
(c) discharging, from the mixer, the composite comprising the filler dispersed in the elastomer at a loading of at least 20 phr, wherein the composite has a liquid content of no more than 10% by weight based on total weight of said composite,
wherein the one or more rotors is mechanically coupled to a mixer motor, and at least a portion of the mixing in step (b) is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point.

Another aspect provides a method of preparing a composite, comprising:
(a) charging a first mixer having one or more rotors with at least a solid elastomer and a wet filler comprising a filler and a liquid present in an amount of at least 15% by weight based on total weight of wet filler;
(b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
   (i) the mixer has at least one temperature-control means that is set to a temperature, Tz, of 65° C. or higher, and
   (ii) the one or more rotors operate, for at least 50% the mixing time, at a tip speed of at least 0.6 m/s, wherein the one or more rotors is mechanically coupled to a mixer motor, and at least a portion of the mixing in step (b) is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point;
(c) discharging, from the first mixer, the mixture comprising the filler dispersed in the elastomer at a loading of at least 20 phr, wherein the mixture has a liquid content that is reduced to an amount less than the liquid content at the beginning of step (b); and
(d) mixing the mixture from (c) in a second mixer to obtain the composite.

Another aspect provides a method of preparing a composite, comprising:
(a) charging a first mixer having one or more rotors with at least a solid elastomer and a wet filler comprising a filler and a liquid present in an amount of at least 15% by weight based on total weight of wet filler;
(b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
   (i) the mixer has at least one temperature-control means that is set to a temperature, Tz, of 65° C. or higher, and
   (ii) the one or more rotors operate, for at least 50% the mixing time, at a tip speed of at least 0.6 m/s;
(c) discharging, from the first mixer, the mixture comprising the filler dispersed in the elastomer at a loading of at least 20 phr, wherein the mixture has a liquid content that is reduced to an amount less than the liquid content at the beginning of step (b); and
(d) mixing the mixture from (c) in a second mixer to obtain the composite, wherein the second mixer has one or more rotors mechanically coupled to a mixer motor, and at least a portion of the mixing in step (b) is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point.

With regard to any aspect or method or embodiment disclosed herein, where applicable, the method can further comprise any one or more of the following embodiments: at least a portion of the mixing in step (b) is performed under PID power control; the power set point, expressed as specific power, ranges from 1 to 10 kW/kg; for (i), the controller continuously calculates the difference between the measured mixer motor power and the power set point; the controller calculates the difference between the measured mixer motor power and the power set point at set time intervals ranging from 0.05 s to 5 s, e.g., from 0.05 s to 1 s; for (ii) the controller continuously adjusts the rotational speed of the one or more rotors if the measured mixer motor power deviates from the power set point; for (ii) the controller continuously adjusts the rotational speed of the one or more rotors if the measured mixer motor power deviates from the power set point; the controller automatically calculates the difference between a measured mixer motor power and a power set point and adjusts the rotational speed of the one or more rotors if the measured mixer motor power deviates from the power set point.

With regard to any aspect or method or embodiment disclosed herein, where applicable, the method can further comprise any one or more of the following embodiments: the mixer is charged with the solid elastomer and the mixing is performed under power control after charging the wet filler to the mixer; the method comprises charging the mixer with at least two portions of the wet filler and the mixing is performed under power control after charging a first portion of the wet filler to the mixer; the mixing is performed under power control after charging each portion of the wet filler to the mixer; the first portion of the at least two portions of the wet filler is at least 50 wt. % the total amount of wet filler charged to the mixer; the solid elastomer is masticated prior to charging the mixer with at least a portion of the wet filler; the solid elastomer is not masticated prior to charging the mixer with at least a portion of the wet filler.

With regard to any aspect or method or embodiment disclosed herein, where applicable, the method can further comprise any one or more of the following embodiments: the wet filler has a liquid present in an amount of at least 20% by weight based on total weight of wet filler, e.g., ranging from 40% to 65% by weight; the filler comprises at least one material selected from carbonaceous materials, carbon black, silica, nanocellulose, lignin, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, and combinations thereof, and coated and treated materials thereof; the filler is selected from rice husk silica, lignin, nanocellulose, hydrothermal carbon, and engineered polysaccharides, and combinations thereof, and coated and treated materials thereof; the filler is selected from carbon nanostructures; the filler is selected from carbon black, silica, silicon-treated carbon black, and blends thereof; the filler is selected from carbon black and silicon-treated carbon black and blends thereof; at least 50% of the filler is selected from carbon black and silicon-treated carbon black and blends thereof; the solid elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof.

With regard to any aspect or method or embodiment disclosed herein, where applicable, the method can further comprise any one or more of the following embodiments: the one or more rotors is selected from two-wing rotors, four-wing rotors, six-wing rotors, eight wing rotors, and one or more screw rotors; the one or more rotors are selected from four-wing rotors, six-wing rotors, and eight wing rotors; the one or more rotors is selected from intermeshing rotors; the mixing time, defined as the time of the charging in (a) to the time of discharging in (c), ranges from 1 min. to 9 min., e.g., from 3 min. to 6 min.

With regard to any aspect or method or embodiment disclosed herein, where applicable, the method can further comprise any one or more of the following embodiments: the mixing is performed in two or more mixing steps; the mixer in (a) is a first mixer and the method further comprises mixing at least a portion of the composite from (c) in a second mixer; the mixer in (a) is a first mixer and the method further comprises: (d) mixing at least a portion of the composite from (c) in a second mixer, wherein the second mixer is operated under at least one of the following conditions: (i) a ram pressure of 5 psi or less; (ii) a ram raised to at least 75% of its highest level; (iii) a ram operated in floating mode; (iv) a ram positioned such that it does not substantially contact the mixture; (v) the mixer is ram-less; and (vi) a fill factor of the mixture ranges from 25% to 70%; and (e) discharging, from the second mixer, the composite having a liquid content of less than 3% by weight based on total weight of said composite; the first and second mixers are the same; the first and second mixers are different mixers; the first and second mixers are collectively a tandem mixer; the second mixer is ram-less; for the mixing in (d), the second mixer is operated under at least one of the following conditions (i) to (vi) for at least 50% of the mixing time.

With regard to any aspect or method or embodiment disclosed herein, where applicable, the method can further comprise any one or more of the following embodiments: the mixer in (a) is a first mixer and the method further comprises mixing at least a portion of the composite from (c) in a second mixer wherein the second mixer has one or more rotors mechanically coupled to a mixer motor, and at least a portion of the mixing in the second mixer is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point; at least a portion of mixing under power control in the second mixer is performed with the ram raised to at least 75% of its highest level; the mixing under power control in the second mixer is performed after the addition of at least one additive.

### BRIEF DESCRIPTION OF THE DRAWING(S)

FIG. 1 depicts mixing curves for the Comparative first stage mix; and

FIG. 2 depicts mixing curves for the Example 1 first stage mix.

### DETAILED DESCRIPTION

PCT Publication No. WO 2020/247663 A1, the disclosure of which is incorporated by reference herein, describes a mixing process with solid elastomer and a wet filler that comprises a filler and a liquid. When applied to a batch process, the presence of the liquid (e.g., water) increases residence time relative to dry mixing processes, which can enable improvement of filler dispersion without substantial degradation of the elastomer. Under certain conditions, e.g., when scaling up, a significant quantity of liquid must be removed, thereby increasing batch times. The batch times can be up to 2-5 times greater than conventional dry mixing processes.

Batch times can be reduced by maximizing the rotational speed of the mixer rotors, which maximizes the input power. Because the power input into the mixer is proportional to the amount of heat generated, increasing the power input increases the rate of water evaporation. However, the extent to which rotational speed can be increased is limited by one or more of the following factors:
speed capability of the mixer rotors, and/or
excessive power peaks after ingredient additions (if the rotational speed is too high after an ingredient addition, the resulting power peak can exceed the capability of the mixer), and/or
excessive steam production (if the rotational speed is too high, the mixer can produce too much steam for the mixer ventilation system, which can create a safety issue when the mixer ram is subsequently raised to add further ingredients).

Disclosed herein are methods to reduce mixing times by controlling rotational speed of the rotors (rotor speed) through mixer power control for at least a portion of mixing a mixture formed from at least a wet filler and a solid elastomer. The mixing times can be single stage or first stage batch times. Accordingly, one aspect disclosed herein is a method of preparing a composite, comprising:
(a) charging a mixer having one or more rotors with at least a solid elastomer and a wet filler comprising a filler and a liquid present in an amount of at least 15% by weight based on total weight of wet filler;
(b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
   (i) the mixer has at least one temperature-control means that is set to a temperature, Tz, of 65° C. or higher, and
   (ii) the one or more rotors operate, for at least 50% the mixing time, at a tip speed of at least 0.6 m/s; and
(c) discharging, from the mixer, the composite comprising the filler dispersed in the elastomer at a loading of at least 20 phr, wherein the composite has a liquid content of no more than 10% by weight based on total weight of said composite,
wherein the one or more rotors is mechanically coupled to a mixer motor, and at least a portion of the mixing in step (b) is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point.

The methods for preparing a composite include the step of charging or introducing into a mixer at least a solid elastomer and a wet filler. The combining of the solid elastomer with wet filler forms a mixture during the mixing step(s). The method further includes, in one or more mixing steps (e.g., one mixing step), conducting said mixing wherein at least a portion of the liquid is removed by evaporation or an evaporation process that occurs during the mixing. The liquid of the wet filler is capable of being removed by evaporation (and at least a portion is capable of being removed under the claimed mixing conditions) and can be a volatile liquid, e.g., volatile at bulk mixture temperatures. For example, a volatile liquid can be distinguished from oils (e.g., extender oils, process oils) which can be present during at least a portion of the mixing as such oils are meant to be present in the composite that is discharged and thus, do not evaporate during a substantial portion of the mixing time.

For the present wet filler, liquid or additional liquid can be added to the filler and is present on a substantial portion or substantially all the surfaces of the filler, which can include inner surfaces or pores accessible to the liquid. Thus, sufficient liquid is provided to wet a substantial portion or substantially all of the surfaces of the filler prior to mixing with solid elastomer. During mixing, at least a portion of the liquid can also be removed by evaporation as the wet filler is being dispersed in the solid elastomer, and the surfaces of the filler can then become available to interact with the solid elastomer.

The liquid used to wet the filler can be, or include, an aqueous liquid, such as, but not limited to, water. The liquid can include at least one other component, such as, but not limited to, a base(s), an acid(s), a salt(s), a solvent(s), a surfactant(s), and/or a processing aid(s) and/or any combinations thereof. The liquid can be or include a solvent(s) that is immiscible with the elastomer used (e.g., alcohols such as ethanol). Alternatively, the liquid consists of from about 80 wt. % to 100 wt. % water or from 90 wt. % to 99 wt. % water based on the total weight of the liquid.

The charging of the solid elastomer and/or the wet filler can occur in one step or addition or in multiple steps or additions. The charging of the solid elastomer and the charging of the wet filler can occur all at once, or sequentially (as single or multiple portions), and can occur in any sequence. As an option, the wet filler is charged to the mixer in two or more portions. As another option, the wet filler is charged to the mixer after at least a portion or substantially all (e.g., at least 90%) of the solid elastomer has been charged to the mixer. For example, the charging can comprise charging substantially all or all of the solid elastomer to the mixer followed by charging two or more portions of the wet filler to the mixer. The first portion of the wet filler, as an option, represents at least 50 wt. % of the total amount of wet filler charged to the mixer, e.g., at least 60 wt. %, at least 70 wt. %, at least 75 wt. %, at least 80 wt. %, or at least 90 wt. %. As another option, the first portion of the wet filler, as an option, represents 50-95 wt. % (e.g., 60-95 wt. %, 70-95 wt. %, 80-95 wt. %, 90-95 wt. %, or 90-99 wt. %) of the total amount of wet filler charged to the mixer. The charging of the solid elastomer or wet filler can occur in any fashion including, but not limited to, conveying, metering, dumping and/or feeding as known in the art.

With regard to mixing, the mixing can be performed in one or more mixing steps. Mixing commences when at least the solid elastomer and wet filler are charged to the mixer and energy is applied to a motor that drives one or more rotors of the mixer. The one or more mixing steps can occur after the charging step is completed or can overlap with the charging step for any length of time. For example, a portion of one or more of the solid elastomers and/or wet fillers can be charged into the mixer before or after mixing commences. The mixer can then be charged with one or more additional portions of wet filler and/or solid elastomer. For batch mixing, the charging step is completed before the mixing step is completed.

When mixing wet filler(s) with solid elastomer(s), certain mixing conditions can be applied. For example, the mixer can have temperature-control means to control temperatures of at least one surface of the mixer. As an option, mixer temperatures can be controlled during both the charging and at least one of the mixing steps. The temperature-control means can be a temperature-controlling device on and/or within the mixer or otherwise associated with the mixer (e.g., connected to the mixer) that heats or cools at least one surface, and/or one or more parts of the mixer. The temperature-control means can be, but is not limited to, the flow or circulation of a heat transfer fluid through channels in one or more parts of the mixer. For example, the heat transfer fluid can be water or heat transfer oil. For example, the heat transfer fluid can flow through the rotors, the mixing chamber walls, the ram, and the drop door. In other embodiments, the heat transfer fluid can flow in a jacket (e.g., a jacket having fluid flow means) or coils around one or more parts of the mixer. As another option, the temperature control means (e.g., supplying heat) can be electrical elements embedded in the mixer. The system to provide temperature-control means can further include means to measure either the temperature of the heat transfer fluid or the temperature of one or more parts of the mixer. The temperature measurements can be fed to systems used to control the heating and cooling of the heat transfer fluid. For example, the desired temperature of at least one surface of the mixer can be controlled by setting the temperature of the heat transfer fluid located within channels adjacent one or more parts of the mixer, e.g., walls, doors, rotors, etc.

The temperature of the at least one temperature-control means can be set and maintained, as an example, by one or more temperature control units (“TCU”). This set temperature, or TCU temperature, is also referred to herein as “T_{z}.” In the case of temperature-control means incorporating heat transfer fluids, T_{z} is an indication of the temperature of the fluid itself.

As an option, the temperature-control means can be set to a temperature, T_{z} of at least 65° C., e.g., at least 70° C., at least 80° C., at least 90° C., or ranging from 65° C. to 140° C., or from 65° C. to 130° C., from 65° C. to 120° C., from 65° C. to 110° C., from 65° C. to 100° C., from 65° C. to 95° C., from 70° C. to 140° C., from 70° C. to 130° C., from 70° C. to 120° C., from 70° C. to 110° C., from 70° C. to 100° C., from 80° C. to 140° C., from 80° C. to 130° C., from 80° C. to 120° C., from 80° C. to 110° C., from 80° C. to 100° C., or other temperatures within or above or below these ranges.

Additional features of temperature control means and T_{z} are described in PCT Publication No. WO 2020/247663 A1, the disclosure of which is incorporated by reference herein.

As an option, the process comprises, in at least one of the mixing steps, conducting the mixing such that one or more rotors operate at a tip speed of at least 0.5 m/s for at least 50% of the mixing time or a tip speed of at least 0.6 m/s for at least 50% of the mixing time. The power inputted into the mixer motor is a function, at least in part, of the speed of the at least one rotor and rotor type. Tip speed, which takes into account rotor diameter and rotor speed, can be calculated according to the formula:

Tip speed,m/s=π×(rotor diameter,m)×(rotational speed,rpm)/60.

As tip speeds can vary over the course of the mixing, as an option, the tip speed of at least 0.5 m/s or at least 0.6 m/s is achieved for at least 50% of the mixing time, e.g., at least 60%, at least 70%, at least 75%, at least 80%, at least 85%, at least 90%, at least 95%, or substantially all of the mixing time. The tip speed can be at least 0.6 m/s, at least 0.7 m/s, at least 0.8 m/s, at least 0.9 m/s, at least 1.0 m/s, at least 1.1 m/s, at least 1.2 m/s, at least 1.5 m/s or at least 2 m/s for at least 50% of the mixing time, or other portions of the mixing listed above. The tip speeds can be selected to minimize the mixing time, or can be from 0.6 m/s to 10 m/s, from 0.6 m/s to 8 m/s, from 0.6 to 6 m/s, from 0.6 m/s to 4 m/s, from 0.6 m/s to 3 m/s, from 0.6 m/s to 2 m/s, from 0.7 m/s to 4 m/s, from 0.7 m/s to 3 m/s, from 0.7 m/s to 2 m/s, from 0.7 m/s to 10 m/s, from 0.7 m/s to 8 m/s, from 0.7 to 6 m/s, from 1 m/s to 10 m/s, from 1 m/s to 8 m/s, from 1 m/s to 6 m/s, from 1 m/s to 4 m/s, from 1 m/s to 3 m/s, or from 1 m/s to 2 m/s, (e.g., for at least 50% of the mixing time or other mixing times described herein). In the alternative or in addition, the tip speeds can be selected to maximize throughput. The time/throughput considerations may take into account that as mixing time decreases, the liquid level in the discharged composite may increase. In certain situations, it may be beneficial to perform the mixing at high tip speed for higher throughput balanced with the desired liquid content of the discharged composite, (e.g. excessively high tip speeds may cause shorter residence or mixing times that may not allow sufficient filler dispersion or sufficient removal of the liquid from the composite).

Additional features for controlling tip speed are described in PCT Publication No. WO 2020/247663 A1, the disclosure of which is incorporated by reference herein.

It is common when mixing for the rotational speed (rpm) to be set to a fixed value. However, while rotational speeds are fixed, the power used by a mixer can be variable. For example, power peaks can result during addition of one or more ingredients, e.g., certain additional filler(s) and certain elastomer(s). In other examples, a power reduction can occur with the addition of other ingredients, e.g., additives such as antidegradants. One aspect provides a mixing method that addresses the variable power issues.

The mixer can be a batch mixer, e.g. an internal mixer having an enclosed mixing chamber. Examples of internal mixers include tangential and intermesh mixers. The chamber capacity of the mixer can be at least 1 L, at least 10 L, at least 20 L, at least 30 L, at least 50 L, at least 100 L, or at least 1000 L, such as from 1 L to 1500 L, from 10 L to 1500 L, from 20 L to 1500 L, from 30 L to 1500 L, from 10 L to 1000 L, from 20 L to 1000 L, from 30 L to 1000 L, from 10 L to 100 L, from 20 L to 100 L, or from 30 L to 100 L. The mixing is performed with at least one rotor positioned within the chamber that is mechanically coupled to a motor. For example, the at least one rotor or the one or more rotors can be screw-type rotors, intermeshing rotors, tangential rotors, kneading rotor(s), and rotors used for extruders. Generally, one or more rotors are utilized in the mixer, for example, the mixer can incorporate one rotor (e.g., a screw type rotor), two, four, six, eight, or more rotors. Sets of rotors can be positioned in parallel and/or in sequential orientation within a given mixer configuration. As an option, the at least one rotor can be selected from two-wing rotors, four-wing rotors, six-wing rotors, eight wing rotors, or other rotors known in the art (e.g., intermeshing rotors). As another option, the at least one rotor can be selected from four-wing rotors, six-wing rotors, eight wing rotors.

One aspect provides a controller configured to control the rotational speed of the rotor(s). The controller can be software provided with an industrial control system (such as a programmable logic controller, PLC) or can be a standalone controller. As an option, the controller is a proportional-integral-derivative (PID) controller in that it performs proportional integral derivative control of the rotational speed of the rotor(s) of the mixer. As an option, the mixing can be performed under proportional and integral control with no derivative (or derivative set to zero).

The controller (i) calculates a difference between a measured mixer motor power and a power set point and (ii) adjusts the rotational speed of the one or more rotors if the measured mixer motor power deviates from the power set point. The controller (having a control loop) is configured to relay a signal to a system that drives the motor (motor drive system that drives one or more motors) where the signal dictates the speed of the rotor(s). The motor is mechanically coupled to the one or more rotors where the motor can be electrically or hydraulically powered. The motor can be coupled to a gear box that is coupled to the rotor(s). Sensors can be located on the power supply to the motor (to measure the electrical power consumed) or can be positioned or otherwise affixed or coupled to the shaft to measure the rotational speed and force by which the power produced by the motor can be calculated. Other mechanical couplings known in the art can also be used.

The power control (e.g., PID power control) or power control loop can comprise measuring the mixer motor power to obtain a measured motor power, e.g., the controller receives a power consumption signal from the motor where the power consumption signal is representative of a power level generated by the motor. A power set point for the motor is predefined (targeted) and serves to constrain the power within a set value. As an option, the power set point (expressed as specific power) ranges from 1 to 10 kW/kg, e.g., from 1 to 9 kW/kg, from 1 to 8.5 kW/kg, from 1 to 8 kW/kg, from 1 to 7 kW/kg, from 1 to 6 kW/kg, from 1 to 5 kW/kg, from 1 to 4 kW/kg, from 2 to 10 kW/kg, from 2 to 9 kW/kg, from 2 to 8.5 kW/kg, from 2 to 8 kW/kg, from 2 to 7 kW/kg, from 3 to 10 kW/kg, from 3 to 9 kW/kg, from 3 to 8.5 kW/kg, from 3 to 8 kW/kg, from 3 to 7 kW/kg, from 4 to 10 kW/kg, e.g., from 4 to 9 kW/kg, from 4 to 8.5 kW/kg, from 4 to 8 kW/kg, from 4 to 7 kW/kg, from 5 to 10 kW/kg, from 5 to 9 kW/kg, from 5 to 8.5 kW/kg, from 5 to 8 kW/kg, from 5 to 7 kW/kg, or from 4.3 to 8.5 kW/kg. As an option, the power set point expressed as specific power for a first stage or single stage mix ranges from 1 to 10 kW/kg and other ranges in between as disclosed herein. As another option, the power set point expressed as specific power for a first stage or single stage mix ranges from 4 to 10 kW/kg and other ranges in between as disclosed herein. The controller (e.g., a PID controller) can be configured to calculate the difference between the measured motor power and the power set point, e.g., by determining an input signal based on a difference between the power consumption signal and the power set point. This difference is used to calculate and adjust the rotational speed (rpm) (or apply a correction to the rotational speed) of the one or more rotor(s) if the measured mixer motor power deviates from the power set point.

Typically, the controller continuously calculates the difference between the measured motor power and the power set point. By “continuously” it is meant that the calculations are performed repeatedly at set time intervals. The set time intervals can be on the order of seconds or fractions of seconds (e.g., every 5 s, every 4 s, every 3 s, every 2 s, every 1 s, every 0.5 s, 0.2 s, every 0.1 s, 0.05 s, or other intervals as known in the art), e.g., ranging from 0.05 s to 5 s, from 0.05 s to 4 s, from 0.05 s to 3 s, from 0.05 s to 2 s, from 0.05 s to 1 s, from 0.05 s to 0.75 s, from 0.05 s to 0.5 s, from 0.05 s to 0.4 s, from 0.05 s to 0.3 s, from 0.05 s to 0.2 s, or from 0.05 s to 0.1 s. Thus, the difference between the measured motor power and a power set point is continuously calculated and the controller adjusts the rotational speed if the measured power deviates from the power set point. In many cases, the measured power almost always deviates from the power set point and the controller continuously adjusts the rotational speed. As an option, the controller processes are automated; the controller automatically measures the motor power, calculates difference between the measured motor power and power set point, and adjusts and thereby controls the rotational speed (rpm) of the rotor(s).

Mixing under power control (e.g., PID power control) can reduce mixing times (batch times) because the controller calculates the difference between the measured power and the power set point and adjusts (where necessary) the rotational speed within a predefined power constraint, i.e., the power set point. For example, in rubber mixing it is normal to have a large power peak after the addition of filler as it incorporates into the elastomer. In this situation the power control loop (e.g., PID power control loop) moderates the rotational speed to avoid excessive power usage. If the power set point is exceeded, the controller detects this difference and adjusts (in this case, reduces) the rotational speed of the rotor(s). As filler incorporation proceeds, the power usage generally subsides (power consumption signal from the motor decreases). If the power drops below the power set point, the power control loop (automatically) adjusts (in this case, raises) the rotational speed to achieve the power set point. By eliminating the high and low extremes of power usage (power consumption signal) and increasing rotational speeds where possible, the batch time can be minimized while avoiding the safety hazards associated with excessive power usage.

As an option, at least 10% of the mixing (mixing time or batch time) in (b) can be performed under power control, e.g., at least 20%, at least 25%, at least 30%, at least 35%, at least 40%, at least 50% of the mixing, e.g., from 25% to 100%, from 25% to 75%, or from 25% to 50% of the mixing is performed under power control. One or more portions of the mixing can be performed under power control; if more than one portion of the mixing is performed under power control, the power set points for each of those portions can be the same or different. For example, the mixing can be performed under power control after each ingredient addition (charge) to the mixing (e.g., one or more portions of wet filler and/or one or more portions of elastomer and/or one or more portions of at least one additive as described herein).

The charging of the solid elastomer and the charging of the wet filler can occur all at once, or sequentially, and can occur in any sequence. One or more portions of the solid elastomer and wet filler can be charged to the mixer. For example, (a) all solid elastomer added first followed by all wet filler, (b) all wet filler added first followed by all solid elastomer, (c) all solid elastomer added first with a portion of wet filler followed by the addition of one or more remaining portions of wet filler, (d) a portion of solid elastomer added and then a portion of wet filler added with the remaining portion(s) of solid elastomer and wet filler added in any order, simultaneously or sequentially, (e) a portion of the wet filler is added first followed by a portion of the solid elastomer with the remaining portion(s) of solid elastomer and wet filler added in any order, simultaneously or sequentially, or (f) at the same time or about the same time, a portion of solid elastomer and a portion of wet filler are added as separate charges to the mixer with the remaining portion(s) of solid elastomer and wet filler added in any order, simultaneously or sequentially. Steps (a) through (f) can also include charging at least one additive to the mixer. Mixing can be performed under power control under any scenario where at least a portion of the wet filler and at least a portion of the solid elastomer have been charged to the mixer.

As an option of the charging step, the solid elastomer can be charged to the mixer prior to charging at least a portion of the wet filler where the solid elastomer is masticated until the solid elastomer reaches a predetermined temperature, e.g., a temperature of about 90° C. or 100° C. or higher prior to charging the wet filler into the mixer. This temperature can be from 90° C. to 180° C., from 100° C. to 180° C., from 110° C. to 170° C., from 120° C. to 160° C., or from 130° C. to 160° C. The elastomer can be masticated using the same mixer or a different mixer, such as an internal mixer such as a Banbury or Brabender mixer, an extruder, a roll mill, a continuous compounder, or other rubber mixing equipment. As another option, the solid elastomer charged to the mixer is not masticated prior to charging the mixer with at least a portion of the wet filler.

As an option, the mixing is performed under power control after charging the mixer with wet filler or after each charge of wet filler if multiple portions of wet filler are used. As a specific example, the mixer can be initially charged with at least a portion of the solid elastomer followed by charging one or more portions of the wet filler to the mixer. The mixing can then be performed under power control after wet filler addition or charging. Additional portion(s) of solid elastomer can be charged to the mixer after at least a portion of the wet filler is charged to the mixer.

As another example, at least a portion of the wet filler is initially charged to the mixer followed by the charging of at least one elastomer. As an option, substantially all of the mixing is performed under power control when at least a portion of the wet filler is initially charged to the mixer. The wet filler can be prepared prior to charging to the mixer or prepared in situ in the mixer, e.g., by charging the mixer with dry filler and the liquid. One or more portions (e.g., at least two portions) of the wet filler can be charged to the mixer and the mixing can performed under power control after charging any or all of the portions of the wet filler to the mixer. As an option, the mixing is performed under power control after charging each portion of the wet filler to the mixer. As an option, the first portion of the wet filler charged to the mixer is at least 50 wt. % of the total amount of wet filler charged to the mixer, or other amounts disclosed herein. As another option, the mixer is charged with at least the solid elastomer and the mixing is performed under power control after charging at least one additive, e.g., at least one antidegradant, to the mixer. Power control can commence either immediately after charging the mixer with the wet filler (or portion of the wet filler) or after the mixture has been mixed for an amount of time to ensure that the pressure in the mixer is sufficiently low enough for the ram to be (substantially) lowered.

The use of power control (e.g., PID power control) in mixing can provide an extra layer of protection against excessive/insufficient power usage. For example, limits on the controller output can be set, e.g., set maximum and/or minimum rotational speeds by predefining the maximum and minimum output (rpm) limits of the control loop. The maximum limit can be set to the mixer's maximum rpm capability, or it can be set to a lower value. The power set point can be selected by taking into consideration any number of factors. As an example, the set point can be selected to avoid excessive power usage that can arise from ingredient addition and/or steam production at any point in the mixing step. The set point can be also selected to maximize the rotational speed capability of the rotor(s), e.g., when power peaks are not anticipated. As an example, higher rotational speeds can be applied to assist in increasing the rate of evaporation of liquid that was introduced to the mixer from the wet filler.

The use of such higher rotational speeds can be unique to mixing with wet filler as there may be a need to rapidly evaporate and/or otherwise remove water from the system. This is in contrast to typical dry mixing processes where batch times are lower and the challenge is to increase batch time to improve filler dispersion in the elastomer without substantially degrading the elastomer.

In any aspect disclosed herein, the controller can have a control loop that is configured to drive the motor. An initial control signal is relayed to the control loop, thereby causing the motor to rotate the rotor(s). A power consumption signal is received from the motor, wherein the power consumption signal is representative of a power level generated by the motor. The method can further comprise determining an input signal based on a difference between the measured motor power (power consumption signal) and the power set point for the motor. The input signal is then relayed to the control loop. The controller (via the control loop) can thereby modify or adjust rotation of the rotor(s).

It is not unusual for the input signal (based on a difference between the measured motor power and the power set point) to the power control loop (e.g., PID power control loop) to be variable due to variations in the process and/or other random variations, which can make it difficult to achieve stable control (e.g., of power) in certain instances. As an option, a signal processing can be applied to the input signal to reduce the variation. A class of signal processing includes a filter. The filter can be applied prior to relaying the input signal to calculate the difference between the measured motor power and the power set point. Filters are well known in the art; an example of such a filter is a Kalman Filter. The input signal will have a signal-to-noise ratio. With the filter, the controller can be configured to filter the input signal to produce a filtered input signal that has an increased signal-to-noise ratio as compared to the input signal. Concurrently, the controller (via the power control loop) can be configured to generate a control signal based on the filtered input signal.

Any one or combination of commercial mixers with one or more rotors, temperature control means, and other components, and associated mixing methods to produce rubber compounds can be used in the present methods, such as those disclosed in PCT Publication No. WO 2020/247663 A1, the disclosure of which is incorporated by reference herein.

By “one or more mixing steps,” it is understood that the steps disclosed herein may be a first mixing step followed by further mixing steps prior to discharging. Alternatively, one or more mixing steps can be a single mixing step, e.g., a one-stage or single stage mixing step or process, in which the mixing is performed under one or more of the following conditions: at least one of the mixer temperatures are controlled by temperature controlled means with one or more rotors operating at a tips speed of at least 0.6 m/s for at least 50% of mixing time, and/or the at least one temperature-control means that is set to a temperature, T_{z}, of 65° C. or higher. In certain instances, in a single stage or single mixing step the composite can be discharged with a liquid content of no more than 10% by weight. In other embodiments, two or more mixing steps or mixing stages can be performed so long as one of the mixing steps is performed under one or more of the stated T_{z} or tip speed conditions.

As indicated, during the one or more mixing steps, in any of the methods disclosed herein, at least some liquid present in the mixture and/or wet filler introduced is removed at least in part by evaporation. As an option, the one or more mixing steps or stages can further remove a portion of the liquid from the mixture by expression, compaction, draining, and/or wringing, or any combinations thereof. Alternatively, a portion of the liquid can be drained from the mixer after or while the composite is discharged.

As an option, the composite is prepared as a single stage (single mixing step) process. As another option, the composite is prepared with two (or more) mixing steps, which can be considered multi-step or multi-stage mixing with a first mixing step or stage and at least a second mixing step or stage. One or more of the multi-stage mixing processes can be batch, continuous, semi-continuous, and combinations thereof so long as the stage comprising mixing the wet filler with solid elastomer (e.g., first stage) is a batch mixing process where the rotational speed of the one or more rotors is automatically controlled by the controller for at least a portion of the mixing, as disclosed herein. In certain cases, two mixing stages can improve efficiency: in a first stage, the primary mixing and filler dispersion process occurs; a second stage mix is performed to further dry the composite under conditions that avoids substantial overheating.

For multi-stage mixing, a first step comprises mixing the wet filler with solid elastomer (e.g., first stage). The method then includes mixing or further mixing the mixture in at least a second mixing step or stage utilizing the same mixer (i.e., the first mixer) and/or utilizing a second mixer(s) that is different from the first mixer. A combination of mixers and processes can be utilized in any of the methods disclosed herein, and the mixers can be used sequentially, in tandem, and/or integrated with other processing equipment. For instance, the first mixer can be a tangential mixer or an intermesh mixer, and the second mixer can be a tangential mixer, an intermesh mixer, an extruder, a kneader, or a roll mill. For instance, the first mixer can be a first tangential mixer, and the second mixer can be a second (different) tangential mixer. As another option, the first and second mixer can be the same in which the composite is discharged from a mixer (first mixer) and then at least a portion of the composite is charged to the same mixer (second mixer). Two or more mixing steps (stages) can be performed with two or more mixers. Alternatively, the first and second mixers can be collectively a tandem mixer. In a tandem mixer, typically the second-stage mixing (second mixing step) is performed with a ram-less mixer. Multi-stage mixing according to the present methods (two or more mixing steps) is performed to evaporate the liquid and disperse filler.

Another aspect provides method of preparing a composite, comprising:
(a) charging a first mixer having one or more rotors with at least a solid elastomer and a wet filler comprising a filler and a liquid present in an amount of at least 15% by weight based on total weight of wet filler;
(b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
   (i) the mixer has at least one temperature-control means that is set to a temperature, T_{z}, of 65° C. or higher, and
   (ii) the one or more rotors operate, for at least 50% the mixing time, at a tip speed of at least 0.6 m/s,
wherein the one or more rotors is mechanically coupled to a mixer motor, and for at least a portion of the mixing in step (b) the rotational speed of the one or more rotors is controlled by a controller by calculating the difference between a measured mixer motor power and a power set point, wherein the controller adjusts the rotational speed of the one or more rotors if the measured mixer motor power deviates from the power set point;
(c) discharging, from the first mixer, the mixture comprising the filler dispersed in the elastomer at a loading of at least 20 phr, wherein the mixture has a liquid content that is reduced to an amount less than the liquid content at the beginning of step (b); and
(d) mixing the mixture from (c) in a second mixer to obtain the composite.

Control of mixing times in the first mixer (or first stage mixing) can allow dispersion of filler into the elastomer to a certain extent, followed by mixing in a second mixer (or second stage mixing) under conditions that would minimize substantial or any degradation the solid elastomer, such as natural rubber or a blend comprising natural rubber. Accordingly, the one or more steps of mixing in the first mixer is accompanied by the evaporation of at least some of the liquid, such that the mixture that is discharged from the first mixer has a liquid content that is reduced to an amount less than the liquid content at the beginning of step (b), e.g., the liquid present in the wet filler. The liquid content can be reduced by 50 wt. %, by 60 wt. %, by 70 wt. %, or more. The amount of liquid content remaining in the discharged mixer can depend on the filler type, elastomer type, filler loading, etc. In certain embodiments, it may be desired to have a certain amount of moisture remaining in the mixture to employ a wet mixing process, and its benefits, in the mixing occurring in the second mixer. Alternatively, with other filler and/or elastomer types, it may be desirable to remove the majority of liquid during the one or more mixing steps in the first mixer. Thus, the discharged mixture can have a liquid content (depending, in part, on the liquid content of the wet filler) ranging from 0.5% to 20% by weight relative to the weight of the mixture, e.g., or other amounts as disclosed in PCT Publication No. WO 2020/247663 A1, the disclosure of which is incorporated by reference herein.

The mixing with the second mixer can be such that the second mixer or second mixing is operated under at least one of the following conditions: (i) a ram pressure of 5 psi or less; (ii) ram raised to at least 75% of the ram's highest level (such as at least 85%, at least 90%, at least 95%, or at least 99% or 100% of the ram's highest level); (iii) a ram operated in floating mode; (iv) a ram positioned such that it does not substantially contact the mixture; (v) a ram-less mixer; and (vi) a fill factor of the mixture (at least solid elastomer and wet filler) ranges from 25% to 70%. As an option, the second mixer can be operated at a fill factor of the mixture, on a dry weight basis, ranging from 25% to 70%, from 25% to 60%, from 25% to 50%, or from 30% to 50%. As an option, the mixing with the second mixer can be performed under these conditions for anywhere from 0% to 100% of the mixing time, e.g., from 10% to 100%, from 20% to 100%, from 30% to 100%, from 40% to 100%, from 50% to 100%, from 60% to 100%, from 70% to 100%, from 80% to 100%, or from 90% to 100% of the mixing time.

The mixing in the second mixer can be performed without power control. Alternatively, at least a portion of the mixing is performed under power control. For example, the second mixer is a batch mixer having one or more rotors mechanically coupled to a mixer motor, and at least a portion of the mixing in the second mixer is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point.

As an option, the power set point (expressed as specific power) for the second stage mix ranges from 1 to 10 kW/kg, e.g., from 1 to 9 kW/kg, from 1 to 8.5 kW/kg, from 1 to 8 kW/kg, from 1 to 7 kW/kg, from 1 to 6 kW/kg, from 1 to 5 kW/kg, from 1 to 4 kW/kg, from 1.5 to 10 kW/kg, from 1.5 to 9 kW/kg, from 1.5 to 8.5 kW/kg, from 1.5 to 8 kW/kg, from 1.5 to 7 kW/kg, from 1.5 to 6 kW/kg, from 1.5 to 5 kW/kg, from 1.5 to 4 kW/kg, from 2 to 10 kW/kg, from 2 to 9 kW/kg, from 2 to 8.5 kW/kg, from 2 to 8 kW/kg, from 2 to 7 kW/kg, from 2 to 6 kW/kg, from 2 to 5 kW/kg, from 2 to 4 kW/kg, or any other ranges disclosed herein, e.g., the same range as for the first stage mix. As an option, the power set point expressed as specific power for a first stage or single stage mix ranges from 1 to 10 kW/kg and other ranges in between as disclosed herein. As another option, the power set point expressed as specific power for a first stage or single stage mix ranges from 4 to 10 kW/kg and other ranges in between as disclosed herein.

As an option, at least a portion of mixing under power control in the second mixer is performed with the ram raised to at least 75% of its highest level. As an option, at least a portion of mixing under power control in the second mixer is performed with a ram-less mixer. As yet another option, the mixing in the second mixer under power control can be performed with the ram down. The method then includes discharging from the last used mixer the composite that is formed such that the composite has a liquid content of no more than 10% by weight (or no more than 5%, no more than 3%, no more than 2%, or no more than 1% by weight, or other amounts disclosed herein) based on the total weight of the composite. Typically, second stage mixing is performed to further dry the composite. In any of the multi-stage processes disclosed herein, the final discharged composite (e.g., the composite discharged after the second or third, or more mixing step) can have a liquid content of no more than 5%. Without wishing to be bound by any theory, the use of power PID control in the second stage can enable greater control of the drying rate during the final stages of drying. For example, with such control the masterbatch can be dried without exceeding the target probe temperature range, e.g., prevents composite from drying too quickly.

As another option, a multi-stage mix comprises a first stage mix that is not performed under power control followed by at least one subsequent stage mix (e.g., a second stage mix) in which at least a portion of the mixing is performed under power control. Accordingly, another aspect provides a method of preparing a composite, comprising:
(a) charging a first mixer having one or more rotors with at least a solid elastomer and a wet filler comprising a filler and a liquid present in an amount of at least 15% by weight based on total weight of wet filler;
(b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
   (i) the mixer has at least one temperature-control means that is set to a temperature, T_{z}, of 65° C. or higher, and
   (ii) the one or more rotors operate, for at least 50% the mixing time, at a tip speed of at least 0.6 m/s;
(c) discharging, from the first mixer, the mixture comprising the filler dispersed in the elastomer at a loading of at least 20 phr, wherein the mixture has a liquid content that is reduced to an amount less than the liquid content at the beginning of step (b); and
(d) mixing the mixture from (c) in a second mixer to obtain the composite,
wherein the second mixer has one or more rotors mechanically coupled to a mixer motor, and at least a portion of the mixing in step (b) is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point.

Additional features of mixing, whether single stage or multi-stage mixing, are described in PCT Publication No. WO 2020/247663 A1, the disclosure of which is incorporated by reference herein.

In any methods disclosed herein, the discharging step from the mixer occurs and results in a composite comprising the filler dispersed in the natural rubber at a total loading of at least 20 phr, e.g., from 20 to 250 phr, or other loadings disclosed herein. Substantially all of the filler charged to the mixer is incorporated in the discharged composite (yield loss of filler is no more than 10%, no more than 5%, no more than 3%, no more than 2%, or no more than 1%).

Mixing time can be determined from time of charging (e.g., time of charging the first component or the beginning of the charging) to time of discharge of the composite, i.e., total mixing time or batch time. For batch internal mixers, mixing time can be determined from ram down time as an alternative parameter, e.g., the time that the mixer is operated with the ram at its lowermost position e.g., fully seated position or with ram deflection (as described in PCT Publication No. WO 2020/247663 A1, the disclosure of which is incorporated by reference herein). The presently disclosed methods (e.g., for a single stage mix or a first stage mix) can result in reduced mixing times, whether it be total mixing time or ram down time, relative to a mixing process performed without power control, e.g., by at least 5% or at least 10% of the total mixing time without power control. Mixing time can be less than 10 min., less than 9 min., less than 8 min., less than 7 min., less than 6 min., or from 1 min. to 10 min., e.g., from 1 min. to 9 min., from 1 min. to 8 min., from 3 min. to 10 min., from 3 min. to 9 min., from 3 min. to 8 min., from 3 min. to 7 min., from 3 min. to 6 min., from 5 min. to 10 min., from 5 min. to 9 min., from 5 min. to 8 min., or from 5 min. to 7 min. Ram down times can be less than total mixing time and can be less than 9 min., less than 8 min., less than 7 min., less than 6 min., or from 1 min. to 9 min., from 1 min. to 8 min., from 3 min. to 9 min., from 3 min. to 8 min., from 3 min. to 7 min., from 3 min. to 6 min., from 3 min. to 5 min., from 5 min. to 9 min., from 5 min. to 8 min., or from 5 min. to 7 min.

The methods further include discharging from the mixer the composite that is formed. The discharged composite can have a liquid content of no more than 10% by weight based on the total weight of the composite, as outlined in the following equation:

Liquid content of composite %=100*[mass of liquid]/[mass of liquid+mass of dry composite]

In any of the methods disclosed herein, the discharged composite can have a liquid content of no more than 10% by weight, such as no more than 9%, no more than 8%, no more than 7%, no more than 6%, no more than 5%, no more than 3%, no more than 2%, or no more than 1% by weight, based on the total weight of the composite. This amount can range from 0.1% to 10%, from 0.5% to 9%, 0.5% to 7%, from 0.5% to 5%, from 0.5% to 3%, from 0.5% to 2% by weight, based on the total weight of the composite discharged from the mixer at the end of the process. Alternatively, where two or more mixing stages are employed, the discharged liquid content from the first stage mix (in which at least solid elastomer and wet filler are charged to the mixer) can be greater than 10% by weight (e.g., less than 20% by weight) and a second or subsequent stage results in further drying such that the composite has a liquid content of no more than 10% by weight or less as disclosed herein. In any of the methods disclosed herein, the liquid content (e.g., “moisture content”) can be the measured weight % of liquid present in the composite based on the total weight of the composite.

In any of the methods disclosed herein, liquid content in the composite can be the measured as weight % of liquid present in the composite based on the total weight of the composite. Any number of instruments are known in the art for measuring liquid (e.g., water) content in rubber materials, such as a coulometric Karl Fischer titration system, or a moisture balance, e.g., from Mettler (Toledo International, Inc., Columbus, OH).

The amount of filler that is loaded into the mixture can be targeted (on a dry weight basis) to be at least 20 phr, at least 30 phr, at least 40 phr, or range from 20 phr to 250 phr, from 20 phr to 200 phr, from 20 phr to 180 phr, from 20 phr to 150 phr, from 20 phr to 100 phr, from 20 phr to 90 phr, from 20 phr to 80 phr, 30 phr to 200 phr, from 30 phr to 180 phr, from 30 phr to 150 phr, from 30 phr to 100 phr, from 30 phr to 80 phr, from 30 phr to 70 phr, 40 phr to 200 phr, from 40 phr to 180 phr, from 40 phr to 150 phr, from 40 phr to 100 phr, from 40 phr to 80 phr, from 35 phr to 65 phr, or from 30 phr to 55 phr or other amounts within or outside of one or more of these ranges. The above phr amounts can also apply to filler dispersed in the elastomer (filler loading). Other filler types, blends, combinations, etc. can be used, such as those disclosed in are disclosed in PCT Publication No. WO 2020/247663 A1, the disclosure of which is incorporated by reference herein.

The wet filler that is used in any of the methods disclosed herein can be a solid material, e.g., a solid bulk material, in the form of a powder, paste, pellet, cake, or slurry, e.g., a solid bulk material, in the form of a powder, paste, pellet, or cake. The wet filler can have a liquid content of at least 15% weight relative to the total weight of the wet filler, e.g., at least 20%, at least 25%, at least 30%, at least 40%, at least 50% by weight, or from 20% to 99%, from 20% to 95%, from 20% to 90%, from 20% to 80%, from 20% to 70%, from 20% to 60%, from 30% to 99%, from 30% to 95%, from 30% to 90%, from 30% to 80%, from 30% to 70%, from 30% to 60%, from 40% to 99%, from 40% to 95%, from 40% to 90%, from 40% to 80%, from 40% to 70%, from 40% to 60%, from 45% to 99%, from 45% to 95%, from 45% to 90%, from 45% to 80%, from 45% to 70%, from 45% to 60%, from 50% to 99%, from 50% to 95%, from 50% to 90%, from 50% to 80%, from 50% to 70%, or from 50% to 60% by weight, relative to the total weight of the wet filler. Other amounts of liquid content are disclosed in PCT Publication No. WO 2020/247663 A1, the disclosure of which is incorporated by reference herein.

The filler can be any conventional filler used with elastomers such as reinforcing fillers. The filler can be particulate or fibrous or plate-like. For example, a particulate filler is made of discrete bodies. Such fillers can often have an aspect ratio (e.g., length to diameter) of 3:1 or less, or 2:1 or less, or 1.5:1 or less. Fibrous fillers can have an aspect ratio of, e.g., 2:1 or more, 3:1 or more, 4:1 or more, or higher. Typically, fillers used for reinforcing elastomers have dimensions that are microscopic (e.g., hundreds of microns or less) or nanoscale (e.g., less than 1 micron). In the case of carbon black, the discrete bodies of particulate carbon black refer to the aggregates or agglomerates formed from primary particles, and not to the primary particles themselves. In other embodiments, the filler can have a platelike structure such as graphenes and reduced graphene oxides.

The filler comprises at least one material selected from carbonaceous materials, carbon black, silica, nanocellulose, lignin, clays, nanoclays, metal oxides, metal carbonates, pyrolysis carbon, graphenes, graphene oxides, reduced graphene oxides, carbon nanotubes, single-wall carbon nanotubes, multi-wall carbon nanotubes, or combinations thereof, and coated and treated materials thereof; the filler comprises at least one material selected from carbon black, silica, and coated and treated materials thereof (e.g., carbon black and/or silica and/or silicon-treated carbon black); at least 50 wt % of the filler is selected from carbon black, and coated and treated materials thereof; at least 90 wt % of the filler is selected from carbon black and coated and treated materials thereof.

The carbon black used in any of the methods disclosed herein can be any grade of reinforcing carbon blacks and semi-reinforcing carbon blacks. Examples of ASTM grade reinforcing grades are N110, N121, N134, N220, N231, N234, N299, N326, N330, N339, N347, N351, N358, and N375 carbon blacks. Examples of ASTM grade semi-reinforcing grades are N539, N550, N650, N660, N683, N762, N765, N774, N787, N990 carbon blacks and/or N990 grade thermal blacks.

The carbon black can have any statistical thickness surface area (STSA) such as ranging from 20 m²/g to 250 m²/g or higher. STSA (statistical thickness surface area) is determined based on ASTM Test Procedure D-5816 (measured by nitrogen adsorption). The carbon black can have a compressed oil absorption number (COAN) ranging from about 30 mL/100 g to about 150 mL/100 g. Compressed oil absorption number (COAN) is determined according to ASTM D3493. As an option, the carbon black can have a STSA ranging from 60 m²/g to 150 m²/g with a COAN of from 70 mL/100 g to 115 mL/100 g.

As stated, the carbon black can be a rubber black, and especially a reinforcing grade of carbon black or a semi-reinforcing grade of carbon black. Carbon blacks sold under the Regal®, Black Pearls®, Spheron®, Sterling®, Propel®, Endure®, and Vulcan® trademarks available from Cabot Corporation, the Raven®, Statex®, Furnex®, and Neotex® trademarks and the CD and HV lines available from Birla Carbon (formerly available from Columbian Chemicals), and the Corax®, Durax®, Ecorax®, and Purex® trademarks and the CK line available from Orion Engineered Carbons (formerly Evonik and Degussa Industries), and other fillers suitable for use in rubber or tire applications, may also be exploited for use with various implementations. Suitable chemically functionalized carbon blacks include those disclosed in WO 96/18688 and US2013/0165560, the disclosures of which are hereby incorporated by reference. Mixtures of any of these carbon blacks may be employed. Carbon blacks having surface areas and structures beyond the ASTM grades and typical values selected for mixing with rubber, such as those described in U.S. Patent Application Publ. No. 2018/0282523, the disclosure of which is incorporated herein by reference, may be used in the wet filler and in the composite made by any of the methods disclosed herein.

The carbon black can be a furnace black, a gas black, a thermal black, an acetylene black, or a lamp black, a plasma black, a recovered carbon black (e.g., as defined in ASTM D8178-19), or a carbon product containing silicon-containing species, and/or metal containing species and the like. The carbon black can be a multi-phase aggregate comprising at least one carbon phase and at least one metal-containing species phase or silicon-containing species phase, i.e., silicon-treated carbon black. In silicon-treated carbon black, a silicon containing species, such as an oxide or carbide of silicon, is distributed through at least a portion of the carbon black aggregate as an intrinsic part of the carbon black. Silicon-treated carbon blacks are not carbon black aggregates which have been coated or otherwise modified, but actually represent dual-phase aggregate particles. One phase is carbon, which will still be present as graphitic crystallite and/or amorphous carbon, while the second phase is silica, and possibly other silicon-containing species). Thus, the silicon-containing species phase of the silicon treated carbon black is an intrinsic part of the aggregate, distributed throughout at least a portion of the aggregate. Ecoblack™ silicon-treated carbon blacks are available from Cabot Corporation. The manufacture and properties of these silicon-treated carbon blacks are described in U.S. Pat. No. 6,028,137, the disclosure of which is incorporated herein by reference.

With regard to the filler, as an option, being at least silica (e.g., at least 50 wt. % silica), one or more types of silica, or any combination of silica(s), can be used in any embodiment disclosed herein. The silica can include or be precipitated silica, fumed silica, silica gel, and/or colloidal silica. The silica can be or include untreated silica and/or chemically-treated silica. The silica can be suitable for reinforcing elastomer composites and can be characterized by a Brunaur Emmett Teller surface area (BET, as determined by multipoint BET nitrogen adsorption, ASTM D1993) of about 20 m²/g to about 450 m²/g; about 30 m²/g to about 450 m²/g; about 30 m²/g to about 400 m²/g; or about 60 m²/g to about 250 m²/g, from about 60 m²/g to about 250 m²/g, from about 80 m²/g to about 200 m²/g. The silica can have an STSA ranging from about 80 m²/g to 250 m²/g, such as from about 80 m²/g to 200 m²/g or from 90 m²/g to 200 m²/g, from 80 m²/g to 175 m²/g, or from 80 m²/g to 150 m²/g. Highly dispersible precipitated silica can be used as the filler in the present methods. Highly dispersible precipitated silica (“HDS”) is understood to mean any silica having a substantial ability to dis-agglomerate and disperse in an elastomeric matrix. Such dispersion determinations may be observed in known manner by electron or optical microscopy on thin sections of elastomer composite. Examples of commercial grades of HDS include, Perkasil® GT 3000GRAN silica from WR Grace & Co, Ultrasil® 7000 silica from Evonik Industries, Zeosil® 1165 MP, 1115 MP, Premium, and 1200 MP silica from Solvay S.A., Hi-Sil® EZ 160G silica from PPG Industries, Inc., and Zeopol® 8741 or 8745 silica from Evonik Industries. Conventional non-HDS precipitated silica may be used as well. Examples of commercial grades of conventional precipitated silica include, Perkasil® KS 408 silica from WR Grace & Co, Zeosil® 175GR silica from Solvay S.A., Ultrasil® VN3 silica from Evonik Industries, and Hi-Sil® 243 silica from PPG Industries, Inc. Precipitated silica with surface attached silane coupling agents may also be used. Examples of commercial grades of chemically-treated precipitated silica include Agilon® 400, 454, or 458 silica from PPG Industries, Inc. and Coupsil silicas from Evonik Industries, for example Coupsil® 6109 silica.

Other suitable fillers include carbon nanostructures (CNSs, singular CNS), a plurality of carbon nanotubes (CNTs) that are crosslinked in a polymeric structure by being branched, e.g., in a dendrimeric fashion, interdigitated, entangled and/or sharing common walls with one another. CNS fillers are described in U.S. Pat. No. 9,447,259, and PCT Publication No. WO 2021/247153, the disclosures of which are incorporated by reference herein. Other suitable fillers include bio-sourced or bio-based materials (derived from biological sources), recycled materials, or other fillers considered to be renewable or sustainable include hydrothermal carbon (HTC, where the filler comprises lignin that has been treated by hydrothermal carbonization as described in U.S. Pat. Nos. 10,035,957, and 10,428,218, the disclosures of which are incorporated by reference, herein), rice husk silica, carbon from methane pyrolysis, engineered polysaccharide particles, starch, siliceous earth, crumb rubber, and functionalized crumb rubber. Exemplary engineered polysaccharides include those described in U.S. Pat. Publ. Nos. 2020/0181370 and 2020/0190270, the disclosures of which are incorporated herein by reference. For example, the polysaccharides can be selected from: poly alpha-1,3-glucan; poly alpha-1,3-1,6-glucan; a water insoluble alpha-(1,3-glucan) polymer having 90% or greater α-1,3-glycosidic linkages, less than 1% by weight of alpha-1,3,6-glycosidic branch points, and a number average degree of polymerization in the range of from 55 to 10,000; dextran; a composition comprising a poly alpha-1,3-glucan ester compound; and water-insoluble cellulose having a weight-average degree of polymerization (DPw) of about 10 to about 1000 and a cellulose II crystal structure. As an option, the at least one filler is selected from rice husk silica, lignin, nanocellulose, hydrothermal carbon, and engineered polysaccharides.

Suitable fillers are also disclosed in disclosed in PCT Publication Nos. WO 2020/247663 A1 and, the disclosure of which is incorporated by reference herein

With regard to the solid elastomer that is used and mixed with the wet filler, the solid elastomer can be considered a dry elastomer or substantially dry elastomer. The solid elastomer can have a liquid content (e.g., solvent or water content) of 5 wt. % or less, based on the total weight of the solid elastomer, such as 4 wt. % or less, 3 wt. % or less, 2 wt. % or less, 1 wt. % or less, or from 0.1 wt. % to 5 wt. %, 0.5 wt. % to 5 wt. %, 1 wt. % to 5 wt. %, 0.5 wt. % to 4 wt. %, and the like. The solid elastomer (e.g., the starting solid elastomer) can be entirely elastomer (with the starting liquid, e.g., water, content of 5 wt. % or less) or can be an elastomer that also includes one or more fillers and/or other components.

Any solid elastomer can be used in the present methods. Exemplary elastomers include natural rubber (NR), functionalized natural rubber, synthetic elastomers such as styrene-butadiene rubber (SBR, e.g., solution SBR (SSBR), emulsion SBR (ESBR), or oil-extended SSBR (OESSB+R)), functionalized styrene-butadiene rubber, polybutadiene rubber (BR), functionalized polybutadiene rubber, polyisoprene rubber (IR), ethylene-propylene rubber (EPDM), isobutylene-based elastomers (e.g., butyl rubber), halogenated butyl rubber, polychloroprene rubber (CR), nitrile rubbers (NBR), hydrogenated nitrile rubber (HNBR), fluoroelastomers, perfluoroelastomers, and silicone rubber, e.g., natural rubber, and blends thereof, e.g., natural rubber, styrene-butadiene rubber, polybutadiene rubber, and blends thereof, e.g., a blend of first and second solid elastomers. Other synthetic polymers that can be used in the present methods (whether alone or as blends) include hydrogenated SBR, and thermoplastic block copolymers (e.g., such as those that are recyclable). Synthetic polymers include copolymers of ethylene, propylene, styrene, butadiene and isoprene. Other synthetic elastomers include those synthesized with metallocene chemistry in which the metal is selected from Ce, Pr, Nd, Sm, Gd, Tb, Dy, Ho, Tm, Yb, Lu, Co, Ni, and Ti. Polymers made from bio-based monomers can also be used, such as monomers containing modern carbon as defined by ASTM D6866, e.g., polymers made from bio-based styrene monomers disclosed in U.S. Pat. No. 9,868,853, the disclosure of which is incorporated by reference herein, or polymers made from bio-based monomers such as butadiene, isoprene, ethylene, propylene, farnesene, and comonomers thereof. If two or more elastomers are used, the two or more elastomers can be charged into the mixer as a blend at the same time (as one charge or two or more charges) or the elastomers can be added separately in any sequence and amount. For example, the solid elastomer can comprise natural rubber blended with one or more of the elastomers disclosed herein, e.g., butadiene rubber and/or styrene-butadiene rubber, or SBR blended with BR, etc. For instance, the additional solid elastomer can be added separately to the mixer and the natural rubber can be added separately to the mixer.

The solid elastomer can be or include natural rubber. If the solid elastomer is a blend, it can include at least 50 wt. % or at least 70 wt. % or at least 90 wt. % natural rubber. The blend can further comprise synthetic elastomers such as one or more of styrene-butadiene rubber, functionalized styrene-butadiene rubber, and polybutadiene rubber, and/or any other elastomers disclosed herein.

Additives can also be incorporated in the mixing steps (e.g., whether in a single-stage mix, or the second stage or third stage of a multi-stage mix) and can include anti-degradants, and one or more rubber chemicals to enable dispersion of filler into the elastomer. Rubber chemicals, as defined herein, include one or more of: processing aids (to provide ease in rubber mixing and processing, e.g. various oils and plasticizers, wax), activators (to activate the vulcanization process, e.g. zinc oxide and fatty acids), accelerators (to accelerate the vulcanization process, e.g. sulphenamides and thiazoles), vulcanizing agents (or curatives, to crosslink rubbers, e.g. sulfur, peroxides), and other rubber additives, such as, but not limit to, retarders, co-agents, peptizers, adhesion promoters (e.g., use of cobalt salts to promote adhesion of steel cord to rubber-based elastomers (e.g., as described in U.S. Pat. No. 5,221,559 and U.S. Pat. Publ. No. 2020/0361242, the disclosures of which are incorporated by reference herein), resins (e.g., tackifiers, traction resins) flame retardants, colorants, blowing agents, and additives to reduce heat build-up (HBU). As an option, the rubber chemicals can comprise processing aids and activators. As another option, the one or more other rubber chemicals are selected from zinc oxide, fatty acids, zinc salts of fatty acids, wax, accelerators, resins, and processing oil.

As an option, at least a portion of mixing under power control in the second mixer is performed after the addition of at least one additive (one or more additives) such as any of the additives disclosed herein, e.g., at least one antidegradant and/or processing aid (e.g. various oils and plasticizers, wax) and/or activators (e.g., zinc oxide and/or fatty acids) and/or accelerators and/or resins and/or processing oil.

The disclosed methods can be used to mix a variety of wet filler(s), solid elastomer(s), and optionally additional dry filler(s) and other additives, as described PCT Publication No. WO 2020/247663 A1, the disclosure of which is incorporated by reference herein.

In any method of producing a composite disclosed herein, the method can further include one or more of the following steps, after formation of the composite:
one or more holding steps;
one or more drying steps can be used to further dry the composite to obtain a dried composite;
one or more extruding steps;
one or more calendaring steps;
one or more milling steps to obtain a milled composite;
one or more granulating steps;
one or more cutting steps;
one or more baling steps to obtain a baled product or mixture;
the baled mixture or product can be broken apart to form a granulated mixture; and/or
one or more mixing or compounding steps; and/or
one or more sheeting steps.

As a further example, the following sequence of steps can occur and each step can be repeated any number of times (with the same or different settings), after formation of the composite:
one or more holding steps to develop further elasticity
one or more cooling steps
drying the composite further to obtain a further dried composite;
mixing or compounding the composite to obtain a compounded mixture;
milling the compounded mixture to obtain a milled mixture (e.g., roll milling);
granulating the milled mixture;
optionally baling the mixture after the granulating to obtain a baled mixture;
optionally breaking apart the baled mixture and mixing.

In addition, or alternatively, the composite can be compounded with one or more additives as disclosed herein, e.g., antidegradants, zinc oxide, fatty acids, zinc salts of fatty acids, wax, accelerators, resins, processing oil, and/or curing agents, and vulcanized to form a vulcanizate. Such vulcanized compounds can have one or more improved properties, such as one or more improved rubber properties, such as, but not limited to, an improved hysteresis, wear resistance and/or rolling resistance, e.g., in tires, or improved mechanical and/or tensile strength, or an improved tan delta and/or an improved tensile stress ratio, and the like.

One or more articles can comprise materials made from the composite or vulcanizates disclosed herein. The composite may be used to produce an elastomer or rubber containing product. As an option, the elastomer composite may be used in or produced for use, e.g., to form a vulcanizate to be incorporated in various parts of a tire, for example, tire treads (such as on road or off-road tire treads), including cap and base, undertread, innerliners, tire sidewalls, tire carcasses, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, weather stripping, windshield wipers, automotive components, liners, pads, housings, wheel and track elements, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, anti-vibration articles, tracks, track pads for track-propelled equipment such as bulldozers, etc., engine mounts, earthquake stabilizers, mining equipment such as screens, mining equipment linings, conveyor belts, chute liners, slurry pump liners, mud pump components such as impellers, valve seats, valve bodies, piston hubs, piston rods, plungers, impellers for various applications such as mixing slurries and slurry pump impellers, grinding mill liners, cyclones and hydrocyclones, expansion joints, marine equipment such as linings for pumps (e.g., dredge pumps and outboard motor pumps), hoses (e.g., dredging hoses and outboard motor hoses), and other marine equipment, shaft seals for marine, oil, aerospace, and other applications, propeller shafts, linings for piping to convey, e.g., oil sands and/or tar sands, and other applications where abrasion resistance and/or enhanced dynamic properties are desired. Further the elastomer composite, via the vulcanized elastomer composite, may be used in rollers, cams, shafts, pipes, bushings for vehicles, or other applications where abrasion resistance and/or enhanced dynamic properties are desired.

Accordingly, articles include vehicle tire treads including cap and base, sidewalls, undertreads, innerliners, wire skim components, tire carcasses, engine mounts, bushings, conveyor belt, anti-vibration devices, weather stripping, windshield wipers, automotive components, seals, gaskets, hoses, liners, pads, housings, and wheel or track elements. For example, the article can be a multi-component tread, as disclosed in U.S. Pat. Nos. 9,713,541, 9,713,542, 9,718,313, and 10,308,073, the disclosures of which are incorporated herein by reference.

### EXAMPLES

Water content in the discharged composite was measured using a moisture balance (Model: HE53, Manufacturer: Mettler Toledo NA, Ohio). The composite was sliced into small pieces (size: length, width, height<5 mm) and 2 to 2.5 g of material was placed on a disposable aluminum disc/plate which was placed inside the moisture balance. Weight loss was recorded for 30 mins at 125° C. At the end of 30 mins, moisture content for the composite was recorded as:

$$moisture content of composite = ( \frac{initial weight - final weight}{initial weight} ) * 100 .$$

Small amounts of organic volatile content (<0.1 wt %) may be included in the moisture test values.

The following tests were used to obtain performance data on each of the vulcanizates:
Tensile stress at 100% elongation (M100) and tensile stress at 300% elongation (M300) were evaluated by ASTM D412 (Test Method A, Die C) at 23° C., 50% relative humidity and at crosshead speed of 500 mm/min. Extensometers were used to measure tensile strain. The ratio of M300/M100 is referred to as tensile stress ratio (or modulus ratio). Elongation at break and tensile strength were also determined according to ASTM D412.
Max tan δ was measured with an ARES-G2 rheometer (Manufacturer: TA Instruments) using 8 mm diameter parallel plate geometry in torsional mode. The vulcanizate specimen diameter size was 8 mm diameter and about 2 mm in thickness. The rheometer was operated at a constant temperature of 60° C. and at constant frequency of 10 Hz. Strain sweeps were run from 0.1-68% strain amplitude. Measurements were taken at ten points per decade and the maximum measured tan δ (“max tan δ”) was reported, also referred to as “tan δ” unless specified otherwise. G′ (10%) (MPa) is the dynamic storage modulus G′ at 10% strain. Payne difference of the compound was calculated from the difference of dynamic storage modulus G′ at 0.1% strain to G′ at 50% strain, i.e., G′ (0.1%)-G′ (50%).
Mooney values were measured with Montech VMV3000 equipment (MonTech USA LLC, Columbia City, IN), set at ML (1+4) @100 C Mooney profile (large rotor, 1 minute preheat, 4 minute test).
Shore A Hardness was measured on vulcanized rubber samples having a thickness of 6 mm or more at 23 C according to ASTM D2240 (1997).

### Example 1

Example 1 describes the preparation of composites and vulcanizates comprising an 80/20 blend of natural rubber (RSS3) and butadiene rubber, with wet carbon black filler to target a loading of 51 phr, in which mixing was performed with PID power control for a portion of the mixing.

### Examples 2 and 3

Examples 2 and 3 describe the preparation of composites and vulcanizates comprising an 80/20 blend of natural rubber (RSS3) and butadiene rubber as in Example 1 (with PID power control for a portion of the mixing), with additional process modifications to further reduce batch time.

### Comparative Example

For the Comparative Example, mixing was performed with the same formulation as Example 1 but without any PID power control in the first stage of mixing.

For Examples 1-3 and the Comparative Example the carbon black was prepared by milling Propel® X25 carbon black (Cabot Corporation) and re-wetting in a pin pelletizer, resulting in moisture content of about 56%. The natural rubber used was standard grade natural rubber RSS3 (Sri Trang Group, Thailand). Technical descriptions of these natural rubbers are widely available, such as in Rubber World Magazine's Blue Book published by Lippincott and Peto, Inc. (Akron, Ohio, USA). The butadiene rubber used was Buna® CB 22 butadiene rubber (“CB22”).

All composites were prepared through a two-stage mixing process. For Examples 1 and 2 and the Comparative, the first stage was conducted on a BB-16 tangential mixer (“BB-16”; Kobelco Kobe Steel Group) fitted with two tangential 4-wing rotors (type 4WN), providing 16.2 L capacity. The first stage mixing of Example 3 and all the second stage mixes were conducted with a BB-16 mixer fitted with two 6-wing tangential rotors (type 6WI), providing 14.4 L capacity.

For Examples 1-3, first stage mixing was performed with PID power control after each addition of the filler. The proportional constant was 200%, the integral constant was 5 s, and no derivative control was used. The power set point was 75 KW (6.4 kW/kg, dry basis) and the maximum output of the power PID control loop was set to 100 rpm. The power input signal used by the power PID control loop was filtered by using a Kalman filter with a K2 constant of 0.005 (see Appendix 1). The control system performed these calculations approximately every 0.2 s. A first stage mix without power PID control was also performed (Comparative) in which the rotor speed was fixed at 80 rpm after each filler addition and after addition of antidegradant (N-(1,3-dimethylbutyl)-N′-phenyl-p-phenylenediamine “6PPD”). In Examples 1, 2, and the Comparative Example, 6PPD was added during the first mixing stage. After the 6PPD addition, Example 1 and Example 2 mixing was performed with power PID control before completion at 100 rpm. In Example 3, 6PPD was added during the second mixing stage.

Table 1 provides the first and second stage mixing conditions for the Comparative and the samples of Examples 1-3.

TABLE 1

| | Comparative | Example 1 | Example 2 | Example 3 |
|---|---|---|---|---|
| 1^{st} Stage Mix Procedure | Table 2 | Table 3 | Table 4 | Table 5 |
| 1^{st} Stage Rotor | 4WN | 4WN | 4WN | 6WI |
| 1^{st} Stage TCU Temp. (° C.) | 90 | 90 | 90 | 90 |
| 1^{st} Stage Ram Pressure (MPa) | 11.2 | 11.2 | 11.2 | 11.2 |
| 1^{st} Stage Fill Factor (%) | 66.0 | 66.0 | 66.0 | 66.0 |
| 1^{st} Stage Dump Temp. (° C.) | 152.5 | 152.5 | 155 | 155 |
| 1^{st} Stage Mixing Time (min.) | 9.83 | 8.87 | 6.92 | 5.62 |
| 1^{st} Stage Ram Down Time (s) | 509 | 451 | 345 | 287 |
| 1^{st} Stage Mixing Energy (kWh) | 5.48 | 5.53 | 5.58 | 4.41 |
| 1^{st} Stage Avg. Power (kW) | 33.4 | 37.4 | 48.4 | 47.1 |
| 1^{st} Stage Avg. Rotor Speed (rpm) | 72.1 | 75.9 | 81.4 | 83.5 |
| 1^{st} Stage Max. Probe Temp. (° C.) | 122 | 119 | 117 | 124 |
| 1^{st} Stage Moisture (%) | 3.3 | 7.7 | 3.5 | 4.3 |
| 2^{nd} Stage Rotor | 6WI | 6WI | 6WI | 6WI |
| 2^{nd} Stage Mix Procedure | Table 6 | Table 6 | Table 7 | Table 8 |
| 2^{nd} Stage TCU Temp. (° C.) | 65 | 65 | 90 | 90 |
| 2^{nd} Stage Ram Pressure (MPa) | N/A | N/A | 5.0 | 5.0 |
| 2^{nd} Stage Fill Factor (%) | 35.0 | 35.0 | 35.0 | 35.0 |
| 2^{nd} Stage Dump Temp (° C.) | 134.8 | 136.1 | 136.6 | 137.7 |
| 2^{nd} Stage Mixing Time (min.) | 7.20 | 7.05 | 3.25 | 4.97 |
| 2^{nd} Stage Mixing Energy (kWh) | 1.82 | 1.82 | 0.87 | 1.01 |
| 2^{nd} Stage Max. Probe Temp. (° C.) | 133 | 127 | 139 | 134 |
| 2^{nd} Stage Moisture (%) | 0.56 | 0.75 | 1.14 | 0.67 |
| 1^{st} and 2^{nd} Stage batch time total | 17.03 | 15.92 | 10.17 | 10.59 |

Table 2 shows the first stage mixing protocol for the Comparative sample. The ram position (“Ram Pos.”) is indicated as Up or Down; “Float” indicates that the hydraulic pressure on the ram has been eliminated. In Float position, the ram is largely down due to its own weight.

TABLE 2

| | Sequence | | End | | | |
|---|---|---|---|---|---|---|
| | Step | Actual Step | Temp | Ram | Mixer | |
| Step | Duration (s) | Duration (s) | (° C.) | Pos. | RPM | Description |
| 1 | 20 | 20 | | Up | 50 | Feed rubber to mixer |
| 2 | 120 max | 120 | 110 | Down | 60 | Masticate rubber until earliest of 120 s |
| | | | | | | and 110° C. |
| 3 | 20 | 20 | | Up | 60 | Add 1st CB Addition (75%). |
| 4 | 120 max | 72 | 130 | Down | 80 | Mix until earliest of 120 s and 130° C. |
| 5 | 20 | 20 | | Up | 60 | Add 2nd CB addition (25%) |
| 6 | 20 | 20 | | Down | 60 | Mix at 60 rpm for 20 s, to allow |
| | | | | | | hydraulic system to reach pressure |
| 7 | Variable | 193 | 147.5 | Down | 80 | Mix until 6PPD addition temperature |
| 8 | 20 | 20 | | Up | 60 | Add 6PPD |
| 9 | Variable | 104 | 152.5 | Down | 80 | Mix until dump temperature of |
| | | | | | | 152.5° C. |
| 10 | 30 | 30 | | Float | 50 | Discharge mixer & close drop door |
| | | | | | | after 30 s |

Table 3 shows the first stage mixing protocol for the Example 1 sample.

TABLE 3

| | Sequence | | End | | | |
|---|---|---|---|---|---|---|
| | Step | Actual Step | Temp | Ram | Mixer | |
| Step | Duration (s) | Duration (s) | (° C.) | Pos. | RPM | Description |
| 1 | 20 | 20 | | Up | 50 | Feed rubber to mixer |
| 2 | 120 max | 120 | 110 | Down | 60 | Masticate rubber until earliest of |
| | | | | | | 120 s and 110° C. |
| 3 | 20 | 20 | | Up | 50 | Add 1st CB Addition (75%). |
| 4 | 20 | 20 | | Down | 50 | Mix at low rpm to allow hydraulic ram |
| | | | | | | system to reach pressure |
| 5 | 120 max | 63 | 130 | Down | Power | Mix under power PID control until |
| | | | | | PID | earliest of 120 s and 130° C. |
| 6 | 20 | 20 | | Up | 50 | Add 2nd CB addition (25%) |
| 7 | 20 | 20 | | Down | 50 | Mix at 50 rpm for 20 s to allow |
| | | | | | | hydraulic system to reach pressure |
| 8 | Variable | 140 | 147.5 | Down | Power | Mix under power PID control until |
| | | | | | PID | 6PPD addition temperature |
| 9 | 20 | 20 | | Up | 50 | Add 6PPD |
| 10 | 20 | 20 | | Down | 50 | Mix at 50 rpm for 20 s to allow |
| | | | | | | hydraulic system to reach pressure |
| 11 | 20 | 20 | 152.5 | Down | Power | Mix under power PID control until |
| | | | | | PID | earliest of 20 s and dump temperature |
| 12 | Variable | 48 | 152.5 | Down | 100 | Mix until dump temperature of |
| | | | | | | 152.5° C. |
| 13 | 30 | 30 | | Float | 50 | Discharge mixer & close drop door |
| | | | | | | after 30 s |

Table 3 shows the specific parts of the batch sequence that were run under PID control. As can be seen, there are parts of the sequence that run in fixed rpm mode. This contrasts with the sequence of Table 2, which shows that every part of the sequence runs in fixed rpm mode. From Table 1, it can be seen that the batch time the first stage mix of Example 1, under PID control, is reduced compared to the Comparative sample, which was mixed without PID control.

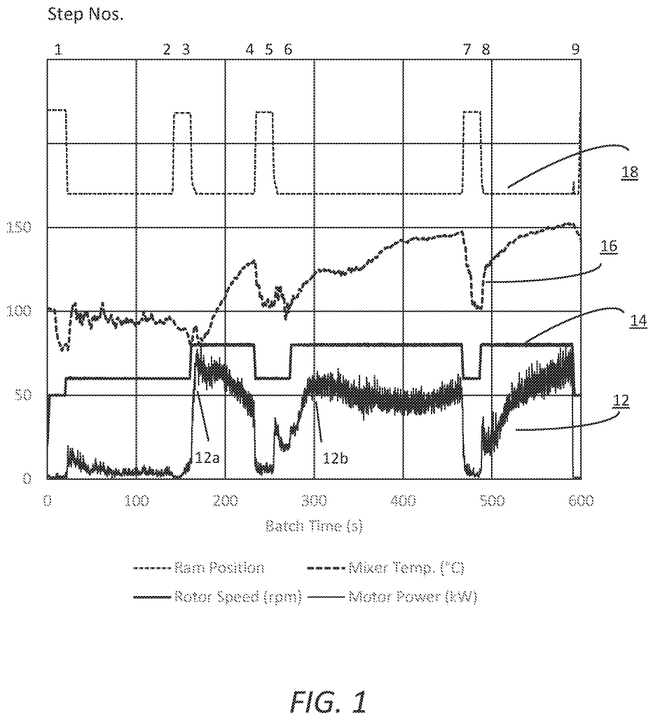

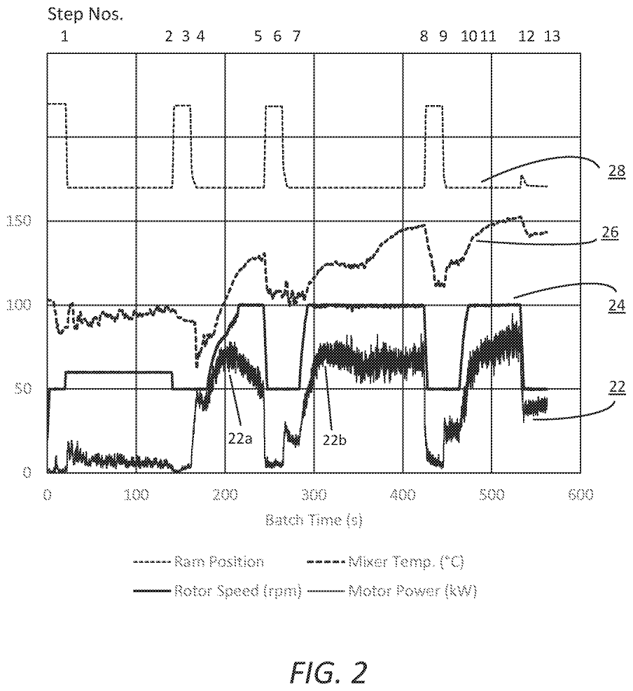

FIGS. 1 and 2 show mixing curves for the Comparative first stage mix (FIG. 1) and Example 1 first stage mix (FIG. 2). FIG. 1 depicts plots of the power curve 12, rotor speed curve 14, and temperature curve 16 (y-axes) as a function of batch time (x-axis) for the Comparative first stage mix. The ram position (unitless) is depicted by plot 18 where the maximum indicates when the ram is operating at its highest level (e.g., “ram up”) and the minimum indicates when the ram is operating at its lowest level (e.g., “ram down”). Similarly for the Example 1 mix, FIG. 2 depicts plots of the power curve 22, rotor speed curve 24, and temperature curve 26 (y-axes) as a function of batch time (x-axis). The ram position (unitless) is depicted by plot 28 where the maximum indicates when the ram is operating at its highest level and the minimum indicates when the ram is operating at its lowest level. The numbers at the top of each of FIG. 1 and FIG. 2 refer to the step numbers of Tables 2 and 3, respectively.

For the Comparative 1st stage mix (FIG. 1), power curve 12 includes a power peak 12a (batch time ˜170 s) that results from the first carbon black addition (corresponding to step 3 of Table 2), the subsequent lowering of the ram, and the subsequent increase in mixer speed to 80 rpm (in step 4 of Table 2). Power peak 12a results in the generation of a high rate of steam from the mixer. The power at peak 12a, however, is close to the maximum safe level for operating this particular mixer. A rotor speed higher than 80 rpm would have increased the rate of steam production, potentially resulting in unsafe operating conditions.

FIG. 2 shows a power curve 22 resulting from the first stage mix operated with power control (Example 1). Power curve 22 has a peak 22a (batch time ˜200 s) occurring after the first filler addition (corresponding to step 3 of Table 3). Power peak 22a is similar in value to that of power peak 12a of the Comparative mix. A higher rotor speed of 100 rpm (see maximum of rotor speed curve 24), however, is possible because the power PID control loop automatically increases the rotor speed such that the power maximum is achieved at a more gradual rate.

In the Comparative mix (FIG. 1), an additional power peak 12b (batch time ˜300 s) in the power curve 12 is also observed after the second carbon black addition (step 6 of Table 2). Power peak 12b and subsequent power usage are lower compared to peak 12a after the first carbon black addition (step 2). These lower values differ from the power profile for the first stage mix of Example 1. Power curve 22 (FIG. 2) also features a second power peak 22b (batch time ˜315 s) after the second carbon black addition (corresponding to step 7 of Table 3). This second power peak 22b, however, is comparable in value to power peak 22a after the first carbon black addition. This is the result of the power PID control loop automatically increasing the mixer speed to attain the power set point. Moreover, high power usage is sustained after power peak 22b by the action of the power PID control loop. This results in a shorter “ram down” mixing time between the second carbon black addition and the next charge (6PPD addition, step 9 of Table 3) than the Comparative Example. This shorter time interval is largely responsible for Example 1 mix having a shorter first stage batch time than the Comparative Example mix. Example 1 also has a shorter batch time for first and second stage batch times combined (see Table 1).

Even with the differences in the power curves and rotor speed curves from the Comparative and Example 1 mixes, the respective temperature curves 16 and 26 are essentially similar.

Tables 4 and 5 provides the first stage mixing protocol for Examples 2 and 3, respectively.

TABLE 4

| | | | End | | | |
|---|---|---|---|---|---|---|
| | Step | Actual Step | Temp | Ram | Mixer | |
| Step | Duration (s) | Duration (s) | (° C.) | Pos. | RPM | Description |
| 1 | 30 | 30 | | Up | 50 | Feed rubber followed by 1st filler |
| | | | | | | addition to mixer (75% of total filler). |
| 2 | 30 | 30 | 110 | Down | 60 | Masticate until earliest of 30 s and |
| | | | | | | 110 C. |
| 3 | Variable | 53 | 130 | Down | Power | Mix under power PID control until |
| | | | | | PID | 130° C. |
| 4 | 20 | 20 | | Up | 50 | Add 2nd Filler Addition. |
| 5 | 20 | 20 | | Down | 50 | Mix at low rpm for 20 s, to allow |
| | | | | | | hydraulic system to reach pressure |
| 6 | Variable | 165 | 150 | Down | Power | Mix under power PID control until |
| | | | | | PID | 6PPD addition temperature. |
| 7 | 20 | 20 | | Up | 50 | Add 6PPD. |
| 8 | 20 | 20 | | Down | 50 | Mix at low rpm for 20 s, to allow |
| | | | | | | hydraulic system to reach pressure |
| 9 | 20 | 20 | 150 | Down | Power | Mix under power PID control until |
| | | | | | PID | earliest of 20 s and dump |
| | | | | | | temperature. |
| 10 | Variable | 37 | 155 | Down | 100 | Mix until target dump temperature of |
| | | | | | | 155° C. |
| 11 | 15 | 15 | | Float | 50 | Discharge Mixer & close Drop Door |
| | | | | | | after 15 s |

TABLE 5

| | | | End | | | |
|---|---|---|---|---|---|---|
| | Step | Actual Step | Temp | Ram | Mixer | |
| Step | Duration (s) | Duration (s) | (° C.) | Pos. | RPM | Description |
| 1 | 30 | 30 | | Up | 50 | Feed rubber followed by (75% of total |
| | | | | | | filler). |
| 2 | 30 | 30 | 110 | Down | 60 | Masticate until earliest of 30 s and |
| | | | | | | 110° C. |
| 3 | Variable | 56 | 130 | Down | Power | Mix under power PID control until |
| | | | | | PID | 130° C. |
| 4 | 20 | 20 | | Up | 50 | 2nd Filler Addition. |
| 5 | 20 | 20 | | Down | 50 | Mix at low rpm for 20 s, to allow |
| | | | | | | hydraulic system to reach pressure |
| 6 | Variable | 180 | 150 | Down | Power | Mix under power PID control until |
| | | | | | PID | target dump temperature of 155° C. |
| 7 | 30 | 30 | | Float | 50 | Discharge mixer & close drop door |
| | | | | | | after 30 s |

From the protocols of Tables 4 and 5, it can be seen that that the first stage mixing of Examples 2 and 3 occurred in a manner similar to that of Example 1 (see Table 3) except the first carbon black addition was added with the rubber in Step 1. This increases the fill factor in Steps 1 and 2, resulting in less ram down mixing time before the second carbon black addition. However, if the mixing between the first and second carbon black additions was performed at fixed speed, a low speed would have to be used to ensure the initial power peak was below the safe maximum level. However, because the majority of the mixing between the first and second carbon black additions occurred under power PID control, the mixer speed was automatically optimized: the mixer speed was automatically moderated during the initial power peak and then automatically increased as the carbon black incorporation proceeded. This automatic optimization of mixer speed resulted in reduced batch time. The first stage mixing time of Example 3 was further reduced by postponing the addition of 6PPD until the second stage mix.

Within 20 min. of completion of the first stage mixes, all second stage mixes were conducted in the BB-16 fitted with two 6-wing tangential rotors (type 6WI), providing 14.4 L capacity. All second stage mixes were performed with the ram raised to its highest position and with temperature PID control, i.e., the mixer rotor speed was automatically modulated by a PID controller, to target a temperature set point. The PID parameters were 100% proportional, 5 seconds integral and no derivative. The temperature control set point was 135° C. and the maximum output of the temperature PID control loop was set to 60 rpm for Example 1 and 70 rpm for Examples 2 and 3. The protocols for the 2nd stage mix are provided in in Table 6 (for Comparative and Example 1), Table 7 (Example 2), and Table 8 (Example 3).

TABLE 6

| | Step Duration | Ram | | |
|---|---|---|---|---|
| Step | (s) | Pos. | Mixer RPM | Description |
| 1 | 20 | Up | 35 | Add stage 1 composite |
| 2 | 90 | Up | 35 | Masticate at fixed speed with ram raised |
| 3 | Variable, | Up | Variable | Masticate under PID temperature control with |
| | based on | | | ram raised using a set point of 135° C. |
| | Operator | | | Speed automatically varied to maintain set |
| | observation | | | point temperature target for step duration. |
| 4 | 30 | Up | 30 | Discharge mixer & close drop door after 30 s |

TABLE 7

| | Step Duration | Ram | | |
|---|---|---|---|---|
| Step | (s) | Pos. | Mixer RPM | Description |
| 1 | 30 | Up | 35 | Add stage 1 composite |
| 2 | 30 | Down | 35 | Masticate at fixed speed with ram down |
| 3 | 30 | Up | 35 | Masticate at fixed speed with ram raised |
| 4 | Variable | Up | Variable | Masticate under PID temperature control with |
| | | | | ram raised using a set point of 135° C. |
| | | | | Speed automatically varied to set point |
| | | | | temperature for step duration. |
| 5 | 30 | Up | 30 | Discharge mixer & close drop door after 30 s |

TABLE 8

| | Step Duration | Ram | | |
|---|---|---|---|---|
| Step | (s) | Pos. | Mixer RPM | Description |
| 1 | 30 | Up | 35 | Add stage 1 composite and 6PPD |
| 2 | 30 | Down | 35 | Masticate at fixed speed with ram down |
| 3 | 30 | Up | 35 | Masticate at fixed speed with ram raised |
| 4 | Variable | Up | Variable | Masticate under PID temperature control with |
| | | | | ram raised, using a set point of 135 C. |
| | | | | Speed automatically varied to maintain set |
| | | | | point temperature for step duration. |
| 5 | 30 | Up | 30 | Speed automatically varied to set point |
| | | | | temperature for step duration. |

The composites were compounded in two stages in a BB-2 tangential mixer (“BB-2”; Kobelco Kobe Steel Group). The BB-2 was fitted with two 4-wing tangential rotors (type 4WN), providing 1.5 L capacity. In the first compounding stage, the following chemicals were added: 3.0 phr zinc oxide, 2.0 phr steric acid, 0.5 phr 6PPD, 1.5 phr TMQ (1,2-dihydro-2,2,4-trimethyl quinoline) and 1.5 phr wax beads. In the second compounding stage, 1.4 phr TBBS (N-tert-butyl-2 benzothiazole sulfenamide) and 1.2 phr sulfur were added as curatives. After compounding, the compounds were sheeted to 2.4 mm thickness on a two-roll mill operated at 60° C. The samples were then cured at 150° C. for 30 minutes, at a pressure of 100 kg/cm². The resulting compound/vulcanizate properties are shown in Table 9.

TABLE 9

| | Comparative | Example 1 | Example 2 | Example 3 |
|---|---|---|---|---|
| Mooney Viscosity ML(1 + 4) (MU) | 99.1 | 102.0 | 101.4 | 86.1 |
| Hardness | 67.2 | 67.8 | 67.8 | 68.4 |
| Room Temperature Tensile Properties: | | | | |
| 100% Modulus (MPa) | 2.42 | 2.44 | 2.50 | 2.37 |
| 300% Modulus (MPa) | 13.2 | 13.6 | 13.9 | 12.6 |
| Tensile Strength (Mpa) | 31.6 | 30.6 | 32.3 | 33.5 |
| Elongation at Break (%) | 560 | 530 | 550 | 600 |
| Strain Sweep @ 10 Hz & 60° C.: | | | | |
| G′ @ 10% strain (MPa) | 2.46 | 2.43 | 2.83 | 2.41 |
| Maximum Tan δ (60° C.) | 0.216 | 0.208 | .207 | 0.217 |
| Indices: | | | | |
| Modulus Ratio | 5.45 | 5.57 | 5.56 | 5.32 |
| Tensile Strength × Elongation to Break | 17700 | 16200 | 17800 | 20100 |
| Payne Difference (MPa)* | 6.77 | 6.33 | 7.55 | 6.72 |

*Payne Difference = G′(0.1%) − G′(50%)

From Table 1 and Table 9, it can be seen that the properties of the vulcanizates of Examples 1 to 3 are similar to properties of the Comparative Example compound. Table 1 shows that first stage mixing with power control (Examples 1 and 2) reduces first stage mixing time (and thus overall time for composite preparation). The corresponding Example 1 vulcanizate achieved rubber properties similar to the vulcanizate made from the Comparative composite. It can be seen that power control successfully resulted in reduced mixing time without any detriment to the rubber properties.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

### Appendix 1: Kalman Filter Description

### Variables:

P=process variable (to be filtered by control system)
E=filtered estimate of P
(calculated by the control system for each time increment of x)
R=rate of change of P with time
(calculated by control system for each time increment of x)
t=time
x=increment of time used by control system (for data input, calculations and data output)
K2=filter constant input by user into control system
K1=filter constant calculated from K2

### Working Equations:

K1=2(K2)**0.5−K2

Et=Et−x+Rt−x+K1(Pt−Et-x−Rt-x)

Rt=Rt-x+K2(Pt−Et)

### Notes

Initial estimates of E and R have to be made (values of 0 are often acceptable).
K2 is empirically selected by user to obtain the desired filtering of P.

1. A method of preparing a composite, comprising:
(a) charging a mixer having one or more rotors with at least a solid elastomer and a wet filler comprising a filler and a liquid present in an amount of at least 15% by weight based on total weight of wet filler;
(b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
(i) the mixer has at least one temperature-control means that is set to a temperature, T_{z}, of 65° C. or higher, and
(ii) the one or more rotors operate, for at least 50% the mixing time, at a tip speed of at least 0.6 m/s; and
(c) discharging, from the mixer, the composite comprising the filler dispersed in the elastomer at a loading of at least 20 phr, wherein the composite has a liquid content of no more than 10% by weight based on total weight of said composite,
wherein the one or more rotors is mechanically coupled to a mixer motor, and at least a portion of the mixing in step (b) is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point.

2. The method of claim 1, wherein at least a portion of the mixing in step (b) is performed under PID power control.

3. The method of claim 1, wherein the power set point, expressed as specific power, ranges from 1 to 10 kW/kg.

4. The method of claim 1, wherein for (i), the controller continuously calculates the difference between the measured mixer motor power and the power set point.

5. The method of claim 4, wherein the controller calculates the difference between the measured mixer motor power and the power set point at set time intervals ranging from 0.05 s to 5 s.

6. The method of claim 4, wherein the controller calculates the difference between the measured mixer motor power and the power set point at set time intervals ranging from 0.05 s to 1 s.

7. The method of claim 1, wherein for (ii) the controller continuously adjusts the rotational speed of the one or more rotors if the measured mixer motor power deviates from the power set point.

8. The method of claim 1, wherein the controller automatically calculates the difference between a measured mixer motor power and a power set point and adjusts the rotational speed of the one or more rotors if the measured mixer motor power deviates from the power set point.

9. The method of claim 1, wherein the mixer is charged with the solid elastomer and the mixing is performed under power control after charging the wet filler to the mixer.

10. The method of claim 9, wherein the method comprises charging the mixer with at least two portions of the wet filler and the mixing is performed under power control after charging a first portion of the wet filler to the mixer.

11. The method of claim 10, wherein the mixing is performed under power control after charging each portion of the wet filler to the mixer.

12. The method of claim 10 wherein the first portion of the at least two portions of the wet filler is at least 50 wt. % the total amount of wet filler charged to the mixer.

13. (canceled)

14. (canceled)

15. The method of claim 1, wherein the filler comprises at least one material selected from carbonaceous materials, carbon black, silica, nanocellulose, lignin, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, rice husk silica, lignin, nanocellulose, hydrothermal carbon, and engineered polysaccharides, carbon nanostructures, and combinations thereof, and coated and treated materials thereof.

16.-19. (canceled)

20. The method of claim 1, wherein at least 50% of the filler is selected from carbon black and silicon-treated carbon black and blends thereof.

21. The method of claim 1, wherein the solid elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof.

22. (canceled)

23. The method of claim 1, wherein the one or more rotors are selected from four-wing rotors, six-wing rotors, and eight wing rotors.

24.-26. (canceled)

27. The method of claim 1, wherein the wet filler has a liquid present in an amount of at least 20% by weight based on total weight of wet filler.

28. The method of claim 1, wherein the wet filler has a liquid present in an amount ranging from 40% to 65% by weight based on total weight of wet filler.

29. The method of claim 1, wherein said mixing is performed in two or more mixing steps.

30. The method of claim 1, wherein the mixer in (a) is a first mixer and the method further comprises mixing at least a portion of the composite from (c) in a second mixer.

31. The method of claim 1, wherein the mixer in (a) is a first mixer and the method further comprises:
(d) mixing at least a portion of the composite from (c) in a second mixer, wherein the second mixer is operated under at least one of the following conditions:
(i) a ram pressure of 5 psi or less;
(ii) a ram raised to at least 75% of its highest level;
(iii) a ram operated in floating mode;
(iv) a ram positioned such that it does not substantially contact the mixture;
(v) the mixer is ram-less; and
(vi) a fill factor of the mixture ranges from 25% to 70%; and
(e) discharging, from the second mixer, the composite having a liquid content of less than 3% by weight based on total weight of said composite.

32. The method of claim 30, wherein the first and second mixers are the same.

33. The method of claim 30, wherein the first and second mixers are different mixers.

34. The method of claim 30, wherein the first and second mixers are collectively a tandem mixer.

35. The method of claim 30, wherein the second mixer is ram-less.

36. The method of claim 31, wherein for the mixing in (d), the second mixer is operated under at least one of the following conditions (i) to (vi) for at least 50% of the mixing time.

37. The method of claim 30, wherein the second mixer has one or more rotors mechanically coupled to a mixer motor, and at least a portion of the mixing in the second mixer is performed under power control in which the rotational speed of the one or more rotors is controlled by a controller that (i) calculates a difference between a measured mixer motor power and a power set point and (ii) adjusts the rotational speed of the one or more rotors if the measured mixer motor power deviates from the power set point.

38. The method of claim 37, wherein at least a portion of mixing under power control in the second mixer is performed with the ram raised to at least 75% of its highest level.

39. The method of claim 37, wherein the mixing under power control in the second mixer is performed after the addition of at least one additive.

40.-41. (canceled)
